(19) United States
(12) Patent Application Publication
(10) Pub. No.: US 2026/0148625 A1
(43) Pub. Date: May 28, 2026

(54) SYSTEM AND METHOD FOR TIMELY DETECTION AND REPORTING TELECOM CABLE AND OTHER TELECOM EQUIPEMENT THEFT

(71) Applicant: Derick D. Schaefer, Dallas, TX (US)

(72) Inventor: Derick D. Schaefer, Dallas, TX (US)

(21) Appl. No.: 19/396,067

(22) Filed: Nov. 20, 2025

Related U.S. Application Data
(60) Provisional application No. 63/724,034, filed on Nov. 22, 2024.

(51) Int. Cl. G08B 13/22; H04M 3/10; H04M 3/24

(52) U.S. Cl. CPC G08B 13/22; H04M 3/10; H04M 3/24

(57) ABSTRACT

A computer system, including: a system for timely detection and reporting telephone cable theft. The system includes on-premise telecommunications equipment containing telegeography and jurisdictional information, a centralized service configured to receive operational status from the telecommunications equipment, interrogate telecommunications equipment, analyze the operational status for potential outages, and predict the likelihood of criminal activity. The operation status indicates a break in a communications cable and that the break is likely due to a copper theft. The system can employ weather data in the prediction of criminal activity and can notify the law enforcement agency based within the jurisdiction of the break in the communications cable.

### CROSS-REFERENCE TO RELATED APPLICATIONS

The present Application claims priority from Provisional Application No. 63/724,034, filed Nov. 22, 2024, entitled “SYSTEM FOR TIMELY DETECTION AND REPORTING TELECOM CABLE AND OTHER TELECOM EQUIPMENT THEFT,” which is hereby incorporated herein by reference in its entirety.

### FIELD OF THE DISCLOSURE

The present disclosure generally relates to theft notification systems, and more particularly to theft notification system with false alarm mitigation.

### BACKGROUND

“Metal theft” is a rapidly growing crime segment. In the telecommunications industry the downstream impact of metal theft is service outages. When criminals cut copper telephone lines, they either disrupt telecommunications activity on the copper line or inadvertently cut fiber optic cable that is attached to the copper line. This leads to immediate disruptions in communication services, which can affect both residential and commercial voice and internet customers. For cities, counties, and municipalities, emergency services (911) can be disrupted.

### SUMMARY

In one aspect, a system is described for timely detection and reporting telephone cable theft is described comprising: an on-premise telecommunications equipment containing telegeography and jurisdictional information, a centralized service configured to: receive operational status from the telecommunications equipment, interrogate telecommunications equipment, analyze the operational status for potential outages, and predict the likelihood of criminal activity. The operation status indicates a break in a communications cable and the break is due to a copper theft. A communication interface is coupled to the centralized service for dispatching notifications to a law enforcement agency based on jurisdictional mapping. The communications interface comprises a pager and may further provide information and alerts through any mainstream or proprietary communications interface, including but not limited to: smartphone applications, social media platforms, email systems, proprietary alerting frameworks, or publish/subscribe (pub/sub) based application programming interfaces (APIs).

The system can employ weather data in the prediction of criminal activity. The law enforcement agency is based within the jurisdiction of the break in the communications cable.

In another aspect, a method of detecting telephone cable theft is described, comprising the steps of: employing on-premise telecommunications equipment containing telegeography and jurisdictional information to monitor operational status of telecommunications equipment, mapping customer address information to jurisdictional areas, and detecting telecommunications equipment outages in jurisdictional areas based on at least one of: a) telemetry from the telecommunications equipment or b) external internet-based check. In other aspects, the method employs of on-premise communications equipment includes at least one of a) using external probing, b) internal alerts, the internet based checks are derived from at least one level of the Open Systems Interconnect (OSI) model, dispatching notifications to law enforcement agencies based on jurisdictional mapping, determining whether an outage is indicative of criminal activity, comprising employing weather data in the prediction of criminal activity, and notifications to law enforcement agency based on jurisdictional mapping and the determination of the outage being determinative of criminal activity.

A computer-readable medium having encoded thereon instructions that, when executed by a computer, perform a method for validating data, the instructions including: instructions for employing on-premise telecommunications equipment containing telegeography and jurisdictional information to monitor operational status of telecommunications equipment, instructions for mapping customer address information to jurisdictional areas, and instructions for detecting telecommunications equipment outages in jurisdictional areas based on at least one of: a) telemetry from the telecommunications equipment or b) external internet-based check; instructions for wherein the employing of on-premise communications equipment includes at least one of a) using external probing, b) internal alerts; instructions for, wherein the internet based checks are derived from at least one level of the Open Systems Interconnect (OSI) model; instructions for dispatching notifications to law enforcement agencies based on jurisdictional mapping; instructions for determining whether an outage is indicative of criminal activity; and instructions for further comprising employing weather data in the prediction of criminal activity.

Other features and advantages of various aspects and embodiments of the present invention will become apparent from the following description and from the claims.

### BRIEF DESCRIPTION OF THE DRAWINGS

For a more complete understanding of this disclosure, reference is now made to the following description, taken in conjunction with the accompanying drawings, in which:

FIG. 1 is a system diagram of a computer system for detecting cabling theft according to one embodiment of the present invention.

FIG. 2. is an alternative system diagram of a computer system for detecting cable theft according to one embodiment of the present invention.

FIG. 3 illustrates a flowchart for detecting cabling theft according to one embodiment of the present invention.

### DETAILED DESCRIPTION

Generally, as appreciated by the inventor, Telecommunications systems are organized based on telegeography, which consists of physical mapping within and across geopolitical boundaries. That is, the geographic locations of telecommunications systems are generally determined and stored in a manner independent of political boundaries. On the other hand, law enforcement is organized around geopolitical boundaries or jurisdictions. When metal or line theft occurs, it causes an immediate telecommunications outage with substantial impact. However, reporting such incidents to law enforcement can take hours or even days, delaying the response and allowing criminals to evade capture. In some cases, the impacted consumer resides in a different jurisdiction from where the cabling was stolen.

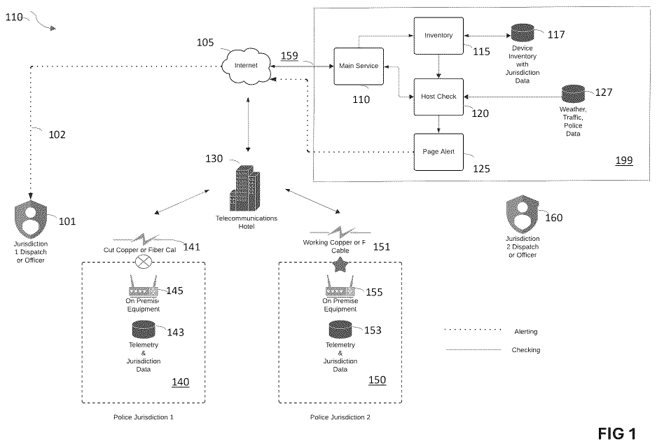

In FIG. 1, in a system 100, as will be described below, the present application addresses this problem generally by mapping telecommunications data from residential or commercial telephony and internet equipment to law enforcement jurisdictions based on equipment address information. The system 100 uses telemetry and reporting information from the equipment, as well as external internet-based checks, to detect an outage, which may be detected in a jurisdiction different from where the equipment theft occurred. Based on identifiable patterns within the telegeography, historical law enforcement incident data, and weather information, the system 100 determines if a telephone or internet outage is likely due to the criminal theft of telecommunications cables or equipment. Alternately, or in addition, the system 100 determines, based on the distribution and timing of detected outages, where the equipment theft that would have likely caused that distribution of outages is likely to have occurred. Notifications are dispatched immediately to the appropriate law enforcement agency based on the jurisdictional mapping within the system.

In FIG. 1, the system 100 includes a jurisdiction or outreach officer 100. The outreach officer is communicating via an alerting channel to an Internet 105. The internet 105 is coupled to a main service element 110 and a telecommunications hotel 130.

The main service element 110 is coupled to an inventory database 115, which is in turn coupled to both a device inventory with jurisdiction data 117 and a host check element 120. The host check element 120 is coupled to both a pager alert element 125 and weather and traffic police data device 127. The page alert element 125, an example of a display interface, is coupled via an alerting channel 129 to the Internet 105.

The telecommunications hotel 130 is coupled to both an on-premise communication equipment 140, within police jurisdiction 1, and an on-premise communication equipment 150, within police jurisdiction 2. On-premise communication equipment 140 includes a cut copper or fiber wire 141, a telemetry and jurisdictional database 143, and on-premise communication equipment 145. On-premise communication equipment 150 includes a working copper or fiber wire 151, a telemetry and jurisdictional database 153, and on-premise communication equipment 155. A second officer 160 is illustrated in FIG. 1, and is illustrated as not the one paged by the system 100.

Generally, the system 100 is presented, which includes two major subsystems: on premise equipment 140, 150 and a centralized service 199. The centralized service 199 includes the telecommunications hotel 130, the main service 110, the inventory 115, the host check 120, the pager alert element 125, the device with jurisdiction data 117, and the weather and police data 127, discussed above.

Generally, telecommunications systems, such as system 100, are organized based on telegeography, which consists of physical mapping within and across geopolitical boundaries. On the other hand, law enforcement is organized around geopolitical boundaries or jurisdictions. When metal or line theft occurs, it causes an immediate telecommunications outage with substantial impact. However, reporting such incidents to law enforcement can take hours or even days, delaying the response and allowing criminals to evade capture. In some cases, the impacted consumer resides in a different jurisdiction from where the cabling was stolen. The system 100 addresses aspects of this problem so as to help alleviate this problem.

Regarding the on-premise equipment 140, 150, a combination of the telemetry and jurisdiction data 143, 153 and the on-premise equipment 145, 155 can include the following functionalities:

Telegeography and Jurisdictional Information: The equipment stores telegeography information, which refers to pole numbers, box numbers, node IDs, customer IDs, IP addresses, customer addresses, fiber ports, and related identifiers. It could also contain jurisdictional information, which refers to neighborhoods, crime watch areas, expanded neighborhood patrol areas, cities, counties, states, and other geopolitical boundaries.

“Phone Home” Functionality: The equipment communicates its operational status (whether it is online or offline) to a centralized service.

External Inquiry Support: It can receive external probes or requests from the centralized service to determine its availability in real-time.

Data Update Capability: It can receive and incorporate updated telegeography and jurisdictional information to ensure the system remains current.

The centralized service 199 can be implemented in hardware or software as a stand-alone systems or as a Software as a Service (SaaS/Cloud) based function or an internal service, deployed on one or more provider's infrastructure, that collects information from on-premise components as well as interrogates on premise components while monitoring the data and using predictive algorithms to determine whether a service outage warrants notifying law enforcement. For events that cross that threshold, it uses a notification service to page, call, or smartphone to notify dispatchers, officers, investigators, or deputies on duty. The centralized services of the centralized service 199 includes:

Status Monitoring: The centralized service 199 tracks whether remote telecommunications equipment is operational or not based on either an external probe or device “phone home” information. The process could involve a combination of the two approaches.

Proactive Probing: It has the ability to proactively check the status of remote equipment.

Outage Detection: By analyzing telegeography information, the service can deterministically predict outages affecting more than one device or customer, indicating potential larger-scale issues.

Crime Prediction: The centralized service processes jurisdictional information and other data sources, such as law enforcement intelligence and weather patterns, to assess whether an outage could be linked to criminal activity like equipment or cable theft.

Law Enforcement Notification: Based on jurisdictional mapping, the system can issue timely alerts or notifications to the appropriate law enforcement agency, ensuring a rapid response to potential crimes.

In at least some embodiments, the telecommunications hotel 130 houses the main service 110, which employs the other elements of the centralized service 199, such as the host check 120 and the page alert 125, to make a determination as to whether a cable theft has occurred, and then to authorize a page alert by the page alert element 125 to the office 101 who is within the proper jurisdiction to respond. This can further include employing an inventory element to determine whether a particular error message corresponds to an inventory type of interests (e.g. copper wires.), a further device inventory with jurisdiction data database 117 to determine which jurisdiction a break may have occurred therein, and a whether traffic, and police data database to help determine if the error message is an indication of an actual theft, or provides weather data, etc, for the main service 110 to determine a probability of theft vs. loss of signal due to inclement weather, etc.

In some embodiments, in the main service 110, a predictive algorithm (“algorithm”) is employed to determine a cable theft outage probability. The algorithm is designed to assess the probability that an outage is caused by cable theft, which should be understood to also include theft of other telecom equipment. The algorithm evaluates various factors, such as the size of the outage, recent theft reports, weather conditions, storm history, infrastructure age, and proximity to known theft incidents, to calculate a likelihood score for theft-related outages, using the elements and databases as reported, above.

In one embodiment, the formula for the probability of theft (P_{theft}) is as follows:

$${P}_{theft} = {P}_{b a s e} + f ( {S}_{outage} ) + f ( {T}_{r e ports} ) + f ( {W}_{c urrent} ) + f ( {H}_{storm} ) + f ( {A}_{infra} ) + f ( {D}_{p r oximity} ) + f ( {I}_{l a w} )$$

Where:
P_{theft} is the probability of the outage being related to cable theft.
P_{base} is the base probability (set to 10% or 0.1).
S_{outage} is the size of the outage.
Tᵣₑₚₒᵣₜₛ is the number of recent cable theft reports in the affected area.
W_{current} is the current weather conditions (e.g. windstorm, precipitation, temperature)
Hₛₜₒᵣₘ is the recent storm history (e.g., within the past 24 hours).
A_{infra} is the age of the telecommunications infrastructure.
D_{proximity} is the distance to recent theft incidents.
I_{law} is a law enforcement intelligence score, ranging from 0 to 10, representing the risk of theft in that area.

### Detailed Calculation

Base Probability—The base probability of theft is 10%, or:

$${P}_{b a s e} = 0.1$$

Outage Size Adjustment—The probability increases based on the size of the outage:

$$f ( {S}_{outage} ) = \{ \begin{matrix}0.1 & if 12 < {S}_{outage} \leq 100 \\ 0.2 & if {S}_{outage} > 100 \\ 0 & if {S}_{outage} \leq 12\end{matrix}$$

Theft Reports Adjustment—The probability increases based on the number of recent theft reports in the area:

$$f ( {T}_{r e ports} ) = 0.05 \times {T}_{r e ports}$$

Weather Conditions Adjustment*—The probability decreases based on current weather conditions:

$$f ( W\_ \{ current \} ) = \{ \begin{matrix}- 0.2 & if NWS windstorm warning issued \\ - 0.1 & if freezing temperatures and precipitation detected \\ 0 & no windstorm or freezing participation\end{matrix}$$

Storm History Adjustment: Recent storm events decrease the probability of theft:

$$f ( {H}_{storm} ) = \{ \begin{matrix}- 0.3 & windstorm or freezing rain in past 24 hours \\ 0 & if no recent storms are reported\end{matrix}$$

Infrastructure Age Adjustment-Older infrastructure increases the likelihood of theft due to the potential presence of dense copper cables:

$$f ( {A}_{infra} ) = \{ \begin{matrix}+ 0.1 if the infrastructure > 20 years old \\ 0 if the infrastructure < 20 years old\end{matrix}$$

Proximity to Theft Adjustment—The closer the outage is to a recent theft incident, the higher the probability:

$$f ( D\_ \{ prox i m ity \} ) = \{ \begin{matrix}\text{.3} & if outage < 1 mile of recent similar report \\ \text{.2} & if outage > 1 mile and < 2 miles of recent similar report \\ 0 & if outage > 2 miles of recent similar report\end{matrix}$$

Law Enforcement Intelligence Adjustment-Law enforcement risk factors increase the likelihood of theft:

$$f ( {I}_{l a w} ) = 0.02 \times {I}_{l a w}$$

Final Probability Calculation—The final probability of the outage being theft-related is clamped between 0% and 100%:

$${P}_{theft} = min ( max ( {P}_{theft} , 0 ) , 1 )$$

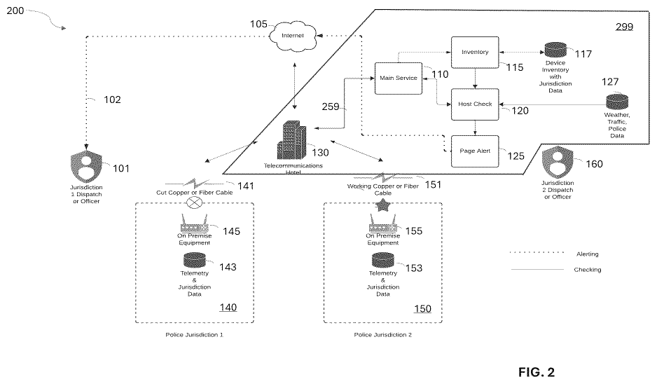

FIG. 2 illustrates a system 200 which includes a detection logic constructed according to the principles of the present application, such as may occur within the telecommunications host 130 inside a centralized service 299.

FIGS. 1 and 2 depict two different logical implementations. In FIG. 1, a first implementation places the detection logic and alerting functionality outside of local or regional telecommunications infrastructure. The second implementation, FIG. 2, places the detection logic inside of the local or regional telecommunications infrastructure; yet still relies on external telecommunications for the alerting functionality.

The following computer programming code written in Go, included in the Appendix, is a live implementation of the methods and overall system. All files are referenced in the “Main Server” code comments and the actual code for Main Server, Host Check, and PagerDuty are included below. A sample of “Inventory” is included in the “Main Server” commentary which shows the telemetry and jurisdiction data implementation. Suitable Pager function API code includes Pager Duty™ available from PagerDuty at pagerduty.com, though the invention is not limited to use of PagerDuty™ code. The invention can also use any suitable code or computer language and is also not limited to Go programming language.

This code was written under the logical implementation 1 design of system 100. Therefore, the host check functionality uses approaches based on OSI Layers 7 (telnet), 4 (TCP), and 3 (ICMP, IPv4, IPv6). If this were built to support an implementation 2 design, lower-level protocols at OSI layers 2 and 1 could be substituted or added supporting a more granular approach. One such approach is included in the Appendix.

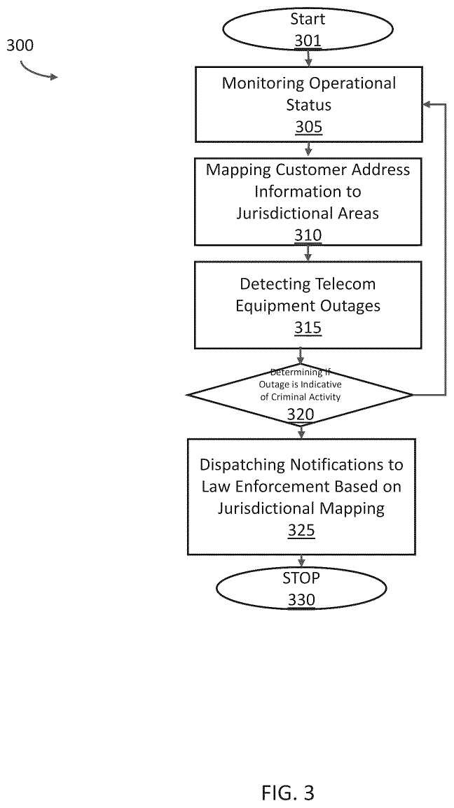

FIG. 3 illustrates a method 300 for detecting cable theft in a telecommunications center. The method 300 starts in a start step 301, which then advances to a step 305.

In a step 305, an operational status is monitored. This operational status can include communication states of a telecom system, and information related to security of that system. The method 300 then advances to a step 310.

In step 310, the customer address of the equipment correlated to the operational status is mapped to a jurisdictional area. The method then advances to a step 315.

In step 315, the operational status is analyzed for a determination as to whether or not there are any equipment outages. The method 300 then advances to a step 320. This determination can be based on at least one of: a) telemetry from the telecommunications equipment or b) external internet-based check.

In the step 320, it is determined whether any equipment outages is indicative of criminal activity, such as according to the algorithms provided in the appendix. This can include whether an outage may be a function of weather conditions. If not indicative, the method 300 loops back to step 305. If there is an indication of criminal activity, the method 300 advances to a step 325.

In a step 325, notifications to law enforcement regarding the indication of criminal activity are dispatched based on the jurisdictional mapping of step 310. The method then stops in a step 330.

It should be understood that although one or more embodiments of the invention have been described in detail primarily directed to an application of the invention to detect and report suspected theft of telecom cables and other equipment, but the present invention is not limited thereto. Rather, it may be applied to detecting and reporting suspected theft of any electrically-connected cable or equipment that includes a telecom interface or connection, physical or wireless.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more machines, such as computers, computer processors, and/or other elements of a computer system. Such features are either impossible or impractical to implement mentally and/or manually. For example, embodiments of the present invention read data from a machine-readable object, such as by using a wand to read data from a chip. This function cannot be performed by a human manually or mentally.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s).

Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors.

Generally, the processor receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic discs such as internal hard discs and removable discs; magneto-optical discs; and CD-ROMs. Any of the foregoing may be supplemented by, or incorporated in, specially designed ASICs (application-specific integrated circuits) or FPGAs (Field-Programmable Gate Arrays).

A computer can generally also receive (read) programs and data from, and write (store) programs and data to, a non-transitory computer-readable storage medium such as an internal disc (not shown) or a removable disc. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the present invention use computerized automatic speech recognition and natural language understanding components to automatically recognize and understand speech, in order to generate a structured note which contains both text and data representing concepts embodied in that text. Such components are inherently computer-implemented and provide a technical solution to the technical problem of automatically generating documents based on speech.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

What is claimed is:

1. A system for timely detection and reporting telephone cable theft, comprising:
an on-premise telecommunications equipment containing telegeography and jurisdictional information;
a centralized service configured to:
receive operational status from the telecommunications equipment,
interrogate telecommunications equipment;
analyze the operational status for potential outages; and
predict the likelihood of criminal activity.

2. The system of claim 1, wherein the operation status indicates a break in a communications cable.

3. The system of claim 2, wherein the break is due to a copper theft.

4. The system of claim 3, further comprising a communication interface coupled to the centralized service for dispatching notifications to a law enforcement agency based on jurisdictional mapping.

5. The system of claim 4, wherein the communications interface comprises a pager and is further configured to provide information and alerts through any of a variety of mainstream or proprietary communication interfaces, including but not limited to smartphone applications, social media platforms, email systems, proprietary alerting frameworks, or publish/subscribe (pub/sub) based application programming interfaces (APIs).

6. The system of claim 5, further configured to employ weather data in the prediction of criminal activity.

7. The system of claim 6, further comprising wherein the law enforcement agency is based within the jurisdiction of the break in the communications cable.

8. A method of detecting telephone cable theft, comprising the steps of:
employing on-premise telecommunications equipment containing telegeography and jurisdictional information to monitor operational status of telecommunications equipment;
mapping customer address information to jurisdictional areas; and
detecting telecommunications equipment outages in jurisdictional areas based on at least one of: a) telemetry from the telecommunications equipment or b) external internet-based check.

9. The method of claim 8, wherein the employing of on-premise communications equipment includes at least one of a) using external probing, b) internal alerts.

10. The method of claim 8, wherein the internet based checks are derived from at least one level of the Open Systems Interconnect (OSI) model.

11. The method of claim 8, further comprising dispatching notifications to law enforcement agencies based on jurisdictional mapping.

12. The method of claim 8, further comprising determining whether an outage is indicative of criminal activity.

13. The method of claim 12, further comprising employing weather data in the prediction of criminal activity.

14. The method of claim 13, further comprising dispatching notifications to law enforcement agency based on jurisdictional mapping and the determination of the outage being determinative of criminal activity.

15. A computer-readable medium having encoded thereon instructions that, when executed by a computer, perform a method for validating data, the instructions including:
instructions for employing on-premise telecommunications equipment containing telegeography and jurisdictional information to monitor operational status of telecommunications equipment;
instructions for mapping customer address information to jurisdictional areas; and
instructions for detecting telecommunications equipment outages in jurisdictional areas based on at least one of: a) telemetry from the telecommunications equipment or b) external internet-based check.

16. The computer-readable medium of claim 15, further comprising:
instructions for wherein the employing of on-premise communications equipment includes at least one of a) using external probing, or b) internal alerts.

17. The computer-readable medium of claim 15, further comprising:
instructions for, wherein the internet based checks are derived from at least one level of the Open Systems Interconnect (OSI) model.

18. The computer-readable medium of claim 15, further comprising:
instructions for dispatching notifications to law enforcement agencies based on jurisdictional mapping.

19. The computer-readable medium of claim 15, further comprising:
instructions for determining whether an outage is indicative of criminal activity.

20. The computer-readable medium of claim 15, further comprising:
instructions for further comprising employing weather data in the prediction of criminal activity.
